(19) United States
(12) Patent Application Publication
(10) Pub. No.: US 2015/0334504 A1
(43) Pub. Date: Nov. 19, 2015

(54) DETERMINING POSITIONS OF MEDIA DEVICES BASED ON MOTION DATA

(71) Applicant: Thomas Alan Donaldson, Nailsworth (GB)

(72) Inventor: Thomas Alan Donaldson, Nailsworth (GB)

(73) Assignee: AliphCom, San Francisco, CA (US)

(21) Appl. No.: 14/279,253

(22) Filed: May 15, 2014

(51) Int. Cl. H04S 7/00

(52) U.S. Cl. CPC H04S 7/303

(57) ABSTRACT

Techniques for positioning devices using motion data are described. Disclosed are techniques for receiving a portion of motion data from one or more sensors coupled to a first device, generating data representing a first displacement of a first device relative to a reference point based on the portion of motion data, and determining a position of the first device relative to a position of a second device based on the first displacement. Various operations may be performed based on the position of the first device. In some examples, an audio signal to be generated at a speaker coupled to the first device may be determined as a function of the position of the first device, and generation of the audio signal at the speaker coupled to the first device may be caused.

### CROSS REFERENCE TO RELATED APPLICATIONS

This application is related to co-pending U.S. patent application Ser. No. 14/266,697, filed Apr. 30, 2014, entitled “Pairing Devices Using Acoustic Signals,” which is incorporated by reference herein in its entirety for all purposes.

### FIELD

Various embodiments relate generally to electrical and electronic hardware, computer software, human-computing interfaces, wired and wireless network communications, telecommunications, data processing, wearable devices, and computing devices. More specifically, disclosed are techniques for positioning media devices or other devices using motion data.

### BACKGROUND

Audio effects, such as surround sound and two-dimensional (2D) and three-dimensional (3D) spatial audio, are becoming increasingly popular. To provide audio effects, different audio channels may be presented at different loudspeakers as a function of the locations or orientations of the loudspeakers. The loudspeakers may be coupled to one or more media devices or speaker boxes. Conventionally, media devices are manually positioned such that an appropriate audio channel may be presented at each media device to provide a desired audio effect. For example, a first audio channel may be configured to be presented from a front right position, a second audio channel may be configured to be presented from a front left position, and a third audio channel may be configured to be presented from a back center position. A user may manually position one media device to be in the front right, one to be in the front left, and one to be in the back center. As another example, a user may position a plurality of media devices in a room, and may manually enter the position of each media device using a user interface. An audio channel may be provided to each media device based on the positions entered by the user.

Thus, what is needed is a solution for positioning devices without the limitations of conventional techniques.

### BRIEF DESCRIPTION OF THE DRAWINGS

Various embodiments or examples (“examples”) are disclosed in the following detailed description and the accompanying drawings:

FIG. 1A illustrates a plurality of media devices in data communication with a position manager, according to some examples;

FIG. 1B illustrates an example of a generation of an audio effect based on a position of one media device relative to another device, according to some examples;

FIG. 2 illustrates an example of a functional block diagram including an application architecture for a position manager, according to some examples;

FIG. 3 illustrates motion data to be used for positioning devices, according to some examples;

FIGS. 4A and 4B illustrate a displacement and orientation of a device, according to some examples;

FIG. 5 illustrates a positioning of more than two devices using motion data, according to some examples;

FIG. 6 illustrates an operation of a device based on a positioning of the device using motion data as well as a distance between the device and a user, according to some examples;

FIG. 7 illustrates a process for a position manager, according to some examples; and

FIG. 8 illustrates a computer system suitable for use with a position manager, according to some examples.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

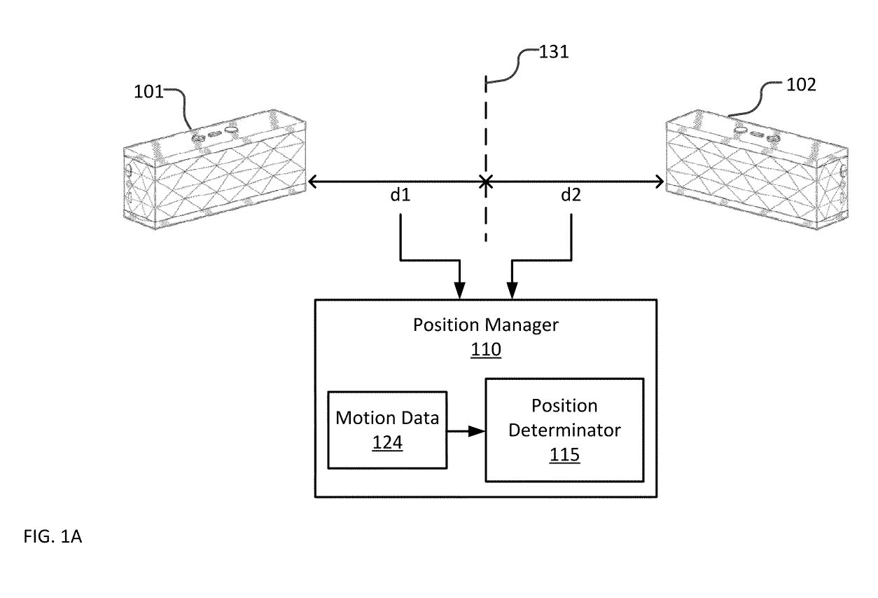

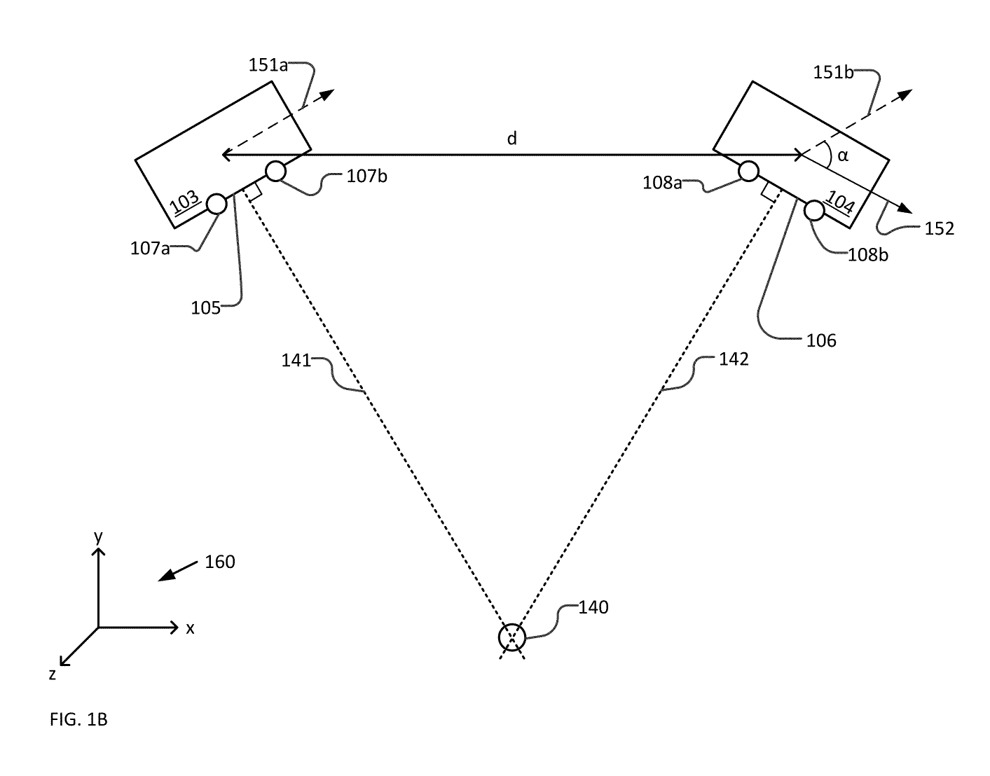

FIG. 1A illustrates a plurality of media devices in data communication with a position manager, according to some examples. As shown, FIG. 1A includes media devices or speaker boxes 101-102, a position manager 110, and a reference position 131, such as a bump position or initial position. Devices 101-102 may start at initial position 131. They may be given an initial trigger or command signal based on detection of motion (e.g., change in acceleration), such as being bumped together, at initial position 131. One or more of devices 101-102 may then be moved, having displacements d1 and d2, respectively. When an object or device is moved from a reference position (such as initial position 131) to an end position, a displacement may refer to a difference between the reference position and the end position, and it may include a magnitude (e.g., distance) and a direction (e.g., angle). Devices 101-102 may each have a motion sensor, which may be used to capture motion data 124. Motion data 124 may be captured as devices 101-102 are being moved. Position manager 110 may receive motion data 124 from devices 101-102 and may analyze and process motion data 124 using a number of facilities, modules, applications, and the like, including without limitation a position determinator 115. Using motion data 124 (and in some examples other data such as location data, ultrasonic data, and the like), position manager 110 may determine one or more of displacements d1 and d2.

Position manager 110 may be configured to determine a position of device 101 relative to device 102 based on motion data 124 based on displacements d1 and d2. The position may include a relative distance, direction, orientation, and the like. For example, device 101 may be moved horizontally to the left with a displacement d1 and device 102 may be moved horizontally to the right with a displacement d2. Then a relative position of device 101 may be a distance of d1+d2 to the left of device 102. The position may include information with respect to a two-dimensional (2D) or three-dimensional (3D) space. For example, position manager 110 may determine the position of device 101 in x and y coordinates, or x, y, and z coordinates, or polar coordinates, or others. Position manager 110 may determine the position of device 101 in terms of a displacement magnitude and a displacement direction. The magnitude may be provided as a distance, and the displacement direction may be provided as an angle. Position manager 110 may determine an orientation of device 101 relative to device 102. The orientation may be provided in terms of one or more angles from a reference. For example, devices 101 and 102 may have a number of sides, such as front, back, left, right, top, and bottom sides. Different interfaces, speakers, buttons, and the like, may be placed on each side. For example, if each respective side of device 101 is facing substantially the same direction as each respective side of device 102 (e.g., the front of device 101 is facing the same direction as the front of device 102, the top of device 101 is facing the same direction as the top of device 102, the right of device 101 is facing the same direction as the right of device 102, etc.), then devices 101-102 may have the same orientation, and a relative rotation angle of device 101 relative to device 102 may be zero (0) degrees.

Position manager 101 may be implemented in device 101, device 102, a server, or another device, or be distributed over any combination of the above devices. Position manager 110 may perform or initiate one or more operations on device 101, device 102, and/or other devices (not shown) as a function of the position of device 101. Position manager 110 may modify functionalities of devices 101-102, access or transmit data to and from devices 101-102, select audio channels or other content to be presented by devices 101-102, terminate communications or transmission of data between devices 101-102, or perform other functions based on the position of device 101. In some examples, devices 101-102 may be configured to provide an audio effect such as surround sound, 2D or 3D spatial audio, and the like. Surround sound is a technique that may be used to enrich the sound experience of a user by presenting multiple audio channels from multiple speakers. 2D or 3D spatial audio may be a sound effect produced by the use multiple speakers to virtually place sound sources in 2D or 3D space, including behind, above, or below the user, independent of the real placement of the multiple speakers. In some examples, at least two transducers operating as loudspeakers can generate acoustic signals that can form an impression or a perception at a listener's ears that sounds are coming from audio sources disposed anywhere in a space (e.g., 2D or 3D space) rather than just from the positions of the loudspeakers. In presenting special audio effects, different audio channels may be mapped to different speakers. One or more loudspeakers may be coupled to each of device 101 and device 102. Each loudspeaker may be configured to present or play an audio channel to provide an audio effect. Position manager 110 may determine an audio signal to be generated at a speaker coupled to device 101 as a function of the position of device 101 relative to device 102. Position manager 110 may cause presentation of the audio signal at the speaker coupled to device 101. Still, other functionalities or operations may be performed.

FIG. 1B illustrates an example of a generation of an audio effect based on a position of one media device relative to another device, according to some examples. As shown, FIG. 1B depicts an x-y-z axis 160, media devices 103-104, a distance d between the devices 103-104, a front side 105 of device 103, a front side 106 of device 104, a normal line 141 from front side 105, a normal line 142 from front side 106, an intersection 140 of the two normal lines 141-142, a left speaker 107a and a right speaker 107b of device 103, a left speaker 108a and a right speaker 108b of device 104, a reference point or line 151a of device 103, a reference point or line 151b of device 103 transposed to device 104, a reference point or line 152 of device 104, an angle α between references 151b and 152 of devices 103-104. Using a position manager, the position of media device 103 relative to device 104 may be determined based on motion data. The relative position of media device 103 may include a distance from device 104, a direction from device 104, an orientation relative to device 104, and the like. For example, as shown, device 103 is a distance d from device 104. Also, device 103 is to the left of device 104, along the x axis. An angle of the direction may be 180 degrees from the x-axis. Also, device 103 has an orientation relative device 104 having an angle α, as indicated by references 151a, 151b, 152. Each device 103-104 may have a similar or equivalent reference point or line against which orientation can be compared. For example, a reference line may run from a center to a side of a device. As another example, a reference line may be a normal to a side of a device. For example, reference 151a indicates a line from the center to a right side of device 103, and reference 152 indicates a line from the center to a right side of device 104. In order to visualize the angle between the references, reference 151b is a transposed version of reference 151a. As shown, an angle α is made by reference 151b and reference 152.

For example, as shown, each device 103-104 may have two speakers on the front side, one on the left and another on the right. In some examples, devices 103-104 may be configured to provide an audio effect for a “sweet spot,” or an optimal location, which is normal to a front side 105-106. Where devices 103-104 are used together, the sweet spot or region may be an area near an intersection 140 of the two normal 141-142. In one example, speakers 107a and 107b may present a left channel and speakers 108a and 108b may present a right channel, which may present an audio effect. As described above, the audio effect may include surround sound, 2D or 3D audio, or others. The audio effect may be best heard or experienced at the sweet spot 140. In one example, each speaker 107a-b, 108a-b may present different channels, which may together provide an audio effect to be heard at sweet spot 140. As the position of device 103 relative to device 104 changes, the location of sweet spot 140 also changes. For example, if device 103 moves in the −x direction and distance d is increased, then sweet spot 140 may move in the −y direction. As another example, as angle of orientation a changes, a location of sweet spot 140 may change. A position manager may determine a position of device 103 relative to device 104 based on motion data. A location of sweet spot 140 may be determined based on the relative position of device 103. In some examples, devices 103-104 may be moved or rotated in the z plane. Additional angles of direction and angles of orientation may be determined by a position manager. Further, in some examples, devices 103-104 may be configured to steer audio signals such that the sweet spot need not necessarily be normal to front sides 105-106. For example, each device 103-104 may have an array or matrix of speakers that may be used to steer audio signals. Based on a relative position of device 103, the array or matrix of speakers may be configured to steer audio signals to a number of sweet spots. Still, other implementations may be used.

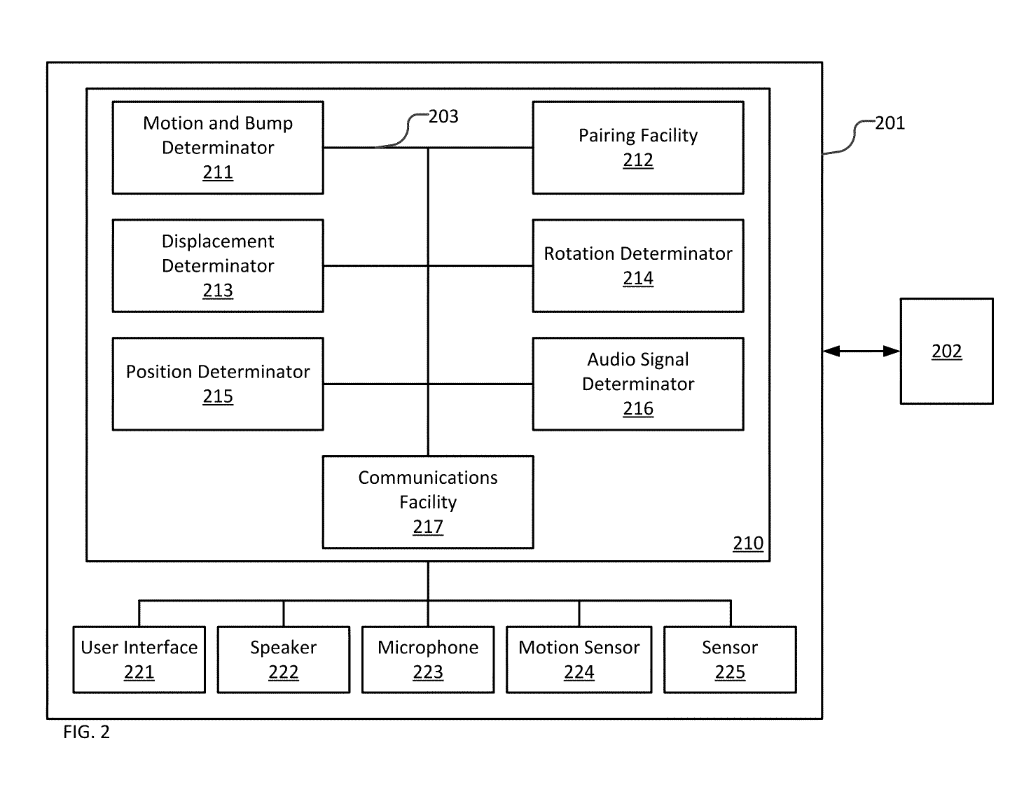

FIG. 2 illustrates an example of a functional block diagram including an application architecture for a position manager, according to some examples. As shown, FIG. 2 includes devices 201-202, position manager 210, bus 203, motion and bump determination facility 211, pairing facility 212, displacement determination facility 213, rotation determination facility 214, position determination facility 215, audio signal determination facility 216, communications facility 217, user interface 221, speaker 222, microphone 223, motion sensor 224, and sensor 225. As used herein, “facility” refers to any, some, or all of the features and structures that are used to implement a given set of functions, according to some embodiments. Position manager 210 may be implemented locally on device 201 (as shown) or remotely (e.g., on a server, a smartphone, another device, etc.). A position manager may also be implemented on device 202. Elements 211-217 may be implemented as part of position manager 210 on device 201 (as shown), separate from position manager 210, or remotely from device 201. In one example, displacement determinator 213 may be implemented locally on device 201. Another displacement determinator may be implemented locally on device 202. Position determinator 215 may be implemented on a server. The server may receive data representing displacements from devices 201-202, and based on the displacements determine a position using position determinator 215. In another example, displacement determinator 213 and position determinator 215 may be implemented on a server. Motion data from motion sensor 224 may be transmitted from device 201 to the server. Elements 221-225 may be local or remote from device 201. Still, other configurations may be possible.

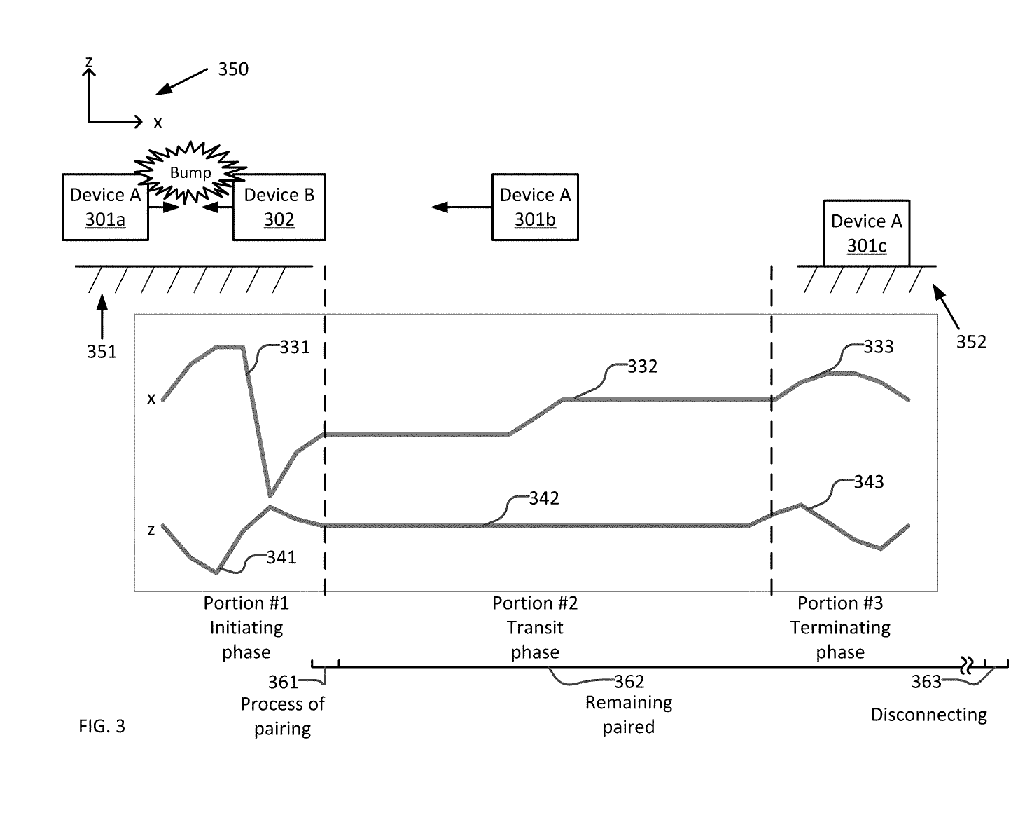

Motion and bump determinator 211 may be configured to determine a motion or change in acceleration to detect an initiation of a process (e.g., via a bump), a termination of a process, and a transit duration. A bump may be associated with a change in acceleration, such as, a device contacting, tapping, knocking, hitting, or colliding with another object or surface, such as another device. A user may bump device 201 against device 202. A bump may serve as an initiating motion, or a trigger or command signal to begin a process of determining a position of device 201. Another initiating motion, or other command signals may be used, such as another motion or gesture, a button coupled to device 201, an entry into user interface 221, and the like. Further, motion and bump determinator 211 may also be configured to determine a terminating motion indicating an end point to be used in determining a position of device 201. The terminating motion may be associated with a user putting down device 201, a user stopping the movement of device 201, and the like. Other command signals may be used, such as another motion or gesture, a button, user interface 221, and the like, as mentioned above. Motion and bump determinator 211 may store one or more templates or conditions associated with a bump, a terminating motion, or other motions used to indicate start and end points for determining a position of device 201. For example, a condition associated with a bump may include a sudden change in acceleration, in terms of magnitude, direction, and/or other parameter. A condition associated with a bump may include a threshold, and the change in motion data must be greater than the threshold in order for the condition to be met. For example, a condition associated with a terminating position may include a sudden change in acceleration, an acceleration indicating that device 201 has been moved downwards (e.g., being put down or placed by a user), and the like. Motion matcher 211 may compare motion data from motion sensor 224 to one or more templates or conditions to determine a match. Motion sensor 224 may be one or more sensors, and may include an accelerometer, gyroscope, inertial sensor, or other sensor that may be used to detect a motion or motion vector. A motion sensor may determine a motion vector with more than one component or axis, such as a 2- or 3-axis accelerometer. A match may be found if the motion data matches the template or condition within a tolerance. For example, if a bump is determined, then subsequent motion data from motion sensor 224 may be used to determine a displacement of device 201. If a terminating motion is determined, then preceding motion data may be used to determine the displacement, and subsequent motion data may not be used. For example, a plurality of portions of motion data may be captured by motion sensor 224 (see, e.g., FIG. 3). A first portion of motion data may be associated with the motion sensed by motion sensor 224 as a user bumps device 201 against device 202, and this portion of motion data may match with a template associated with a bump. The next portion of motion data may be associated with the motion sensed by motion sensor 224 as a user moves device 201, and this portion of motion data may be used to determine a displacement of device 201, including, for example, the distance between starting and end points, a direction of the end point with respect to the starting point, a rotation of device 201 at the end point with respect to the starting point, and the like. The next portion of motion data may be associated with the motion sensed by motion sensor 224 as the user puts down device 201, and this portion of motion data may match with a template associated with a terminating motion. In some examples, other types of data may be used to determine a bump, a terminating motion, and the like. For example, substantially at or around the time of the bump, a data signal or an electromagnetic signal may be transmitted between devices 201-202 using wireless communications, such as Bluetooth, Near Field Communications (NFC), Wi-Fi, and the like. For example, within a time range after motion data matching a bump template is received, device 201 may receive a data signal from device 202. Device 201 may determine that a received signal strength indication (RSSI), or a strength or power level associated with the data signal, is above a threshold power level, which may indicate that device 201 and device 202 are within a close proximity, which may correspond with bumping devices 201-202 together. As another example, substantially at or around devices 201-202 are bumped together and are in close proximity, device 202 may send data to device 201, including data associated with a time of the bump, an acceleration, speed, direction, or other parameter of the bump, and the like. This data may be used to confirm or verify that device 201 was bumped against device 202. For example, if device 202 sends data to device 201 indicating the time when device 202 detected motion data matching a bump, and this time is substantially similar to the time when device 201 detected motion data matching a bump, then device 201 may confirm that it was bumped against device 202.

Pairing facility 212 may be configured to pair devices 201-202. After devices 201-202 are bumped together, or another command signal is given, devices 201-202 may be paired. Pairing of devices 201-202 may be performed using acoustic signals, as described in co-pending U.S. patent application Ser. No. 14/266,697, filed Apr. 30, 2014, entitled “Pairing Devices Using Acoustic Signals,” which is incorporated by reference herein in its entirety for all purposes. In another example, device 202 may capture motion data associated with a bump, and determine a parameter associated with the motion data, such as a time of the bump, an acceleration of the bump, and the like. Device 201 may also capture motion data associated with a bump, and determine a parameter associated with the motion data. Device 202 may transmit a data packet including data associated with the bump and data identifying itself. Device 201 may compare the data associated with the bump received from device 202 with the data associated with the bump generated by device 201. If a match or correlation between bump parameters from device 201 and device 202 is found, device 201 may use the data identifying device 202 to pair with device 202. Still, other methods for pairing devices 201-202 may be used. Pairing may include creating secure communications between the devices. Pairing may include creating an ad hoc network or a connection between devices, whereby the devices may transmit and receive data to and from each other. Data may be exchanged using a number of wireless communications protocols, including Bluetooth, maintained by Bluetooth Special Interest Group (SIG) of Kirkland, Wash., ZigBee, maintained by ZigBee Alliance of San Ramon, Calif., Z-Wave, maintained by Z-Wave Alliance, Wireless USB, maintained by USB Implementers Forum, Inc., and the like. Pairing may include generating or storing a shared key or link key between the devices, which may be used to authenticate the connection or trusted relationship between the paired devices. Authentication may include, for example, encrypting and decrypting data, creating encryption keys, and the like. Once paired, devices 201-202 may share data with each other, including data representing audio signals or audio channels, data representing user settings, control signals, and the like. In other examples, pairing facility 212 may not be used. Devices 201-202 may communicate with an intermediary or a server, which may facilitate communication between devices 201-202. Other forms of communications other than wireless radio signals may be used, such as using acoustic signals, and the like.

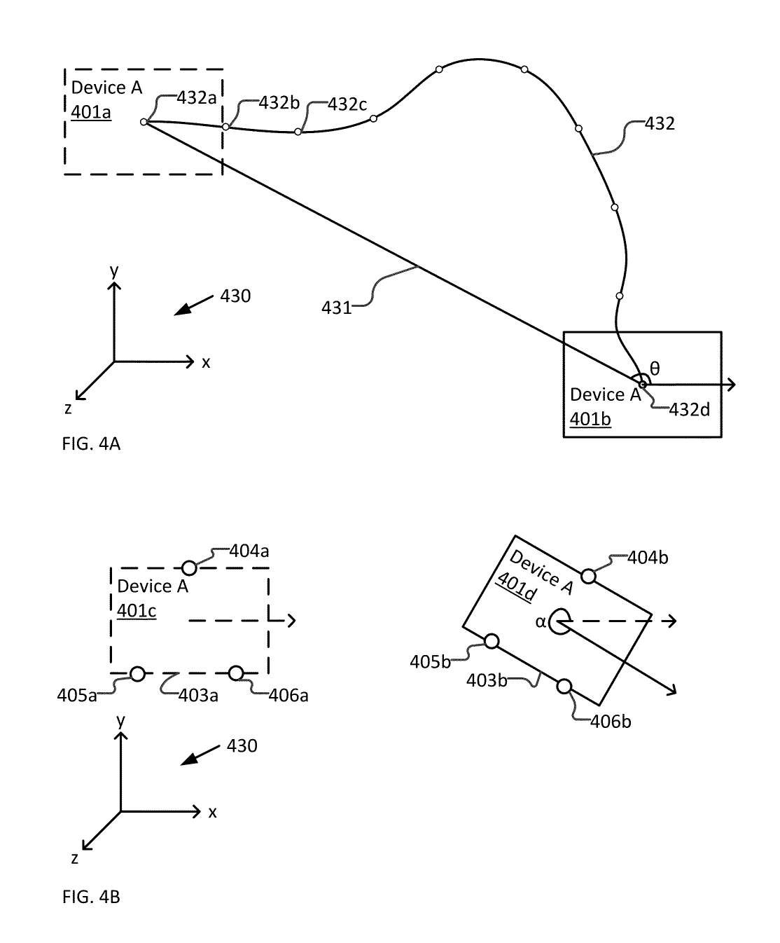

Displacement determinator 213 may be configured to determine a displacement of device 201 using motion data sensed by motion sensor 224. The displacement of device 201 may be determined based on the portion of motion data between a portion of motion data matching a bump template and another portion of motion data matching a terminating motion template. A displacement may be a shortest distance from an initial position to a final position of a point or object. It may be a length of a straight line between the initial and final positions. A displacement may be a vector, including a distance and a direction. It may be the same as or different from the distance or path traveled by the object. Motion data may be used to determine a distance and direction that device 201 is moved, from which a displacement may be determined. For example, device 201 may not be moved in a straight line. Device 201 may be moved around a room, and then placed at a final position by a user. A displacement of device 201 may be the distance between the initial position and the final position, irrespective of the path that was taken by device 201. For example, acceleration data may be sampled at a certain frequency. The acceleration data may be processed to determine a final position or displacement (see, e.g., FIG. 4A). Still, other data may be used. For example, ultrasonic signals, Global Positioning System (GPS) data, location data, and other data may be used to determine or confirm a displacement of device 201.

Rotation determinator 214 may be configured to determine a rotation of device 201 using motion data sensed by motion sensor 224. A rotation may be in 2D or 3D. A 2D rotation may involve one angle of rotation. A 3D rotation may involve two angles of rotation. Motion sensor 224 may capture motion data indicating a rotation. For example, a gyroscope may be used to calculate orientation and rotation. Accelerometers may also be used to determine a rotation. For example, multiple accelerometers may be placed on multiple locations of device 201, and used to determine a rotation. Based on the rotation, position manager 210 may determine a direction of a front side of device 201, which may be a direction in which sound, an audio effect, or other content may be directed (see, e.g., FIG. 4B). For example, a front side may be coupled to two speakers or transducers, and an audio effect may be presented in a direction that is normal to the front side.

Position determinator 215 may be configured to determine a position of device 201 relative to device 202 based on a displacement of device 201 and a displacement of device 202. Position determinator 215 may also determine a position of device 201 relative to device 202 based on a rotation of device 201 and a rotation of device 202. In some examples, data representing a displacement of device 201 may be determined locally by displacement determinator 213. In some examples, data representing displacement of device 201 may be determined locally at device 201, and transmitted to a position determinator implemented at a server. In some examples, motion data from motion sensor 224 may be transmitted to a server, where a displacement determinator and a position determinator are implemented. In some examples, data representing a displacement of device 202 may be transmitted to position manager 210. The transmission of data may be performed using wired or wireless communications (using, e.g., communications facility 217), acoustic signals (using, e.g., speaker 222 and microphone 223), and the like. Other configurations and networks may also be used. Once displacements of devices 201-202 are received, a position may be determined. A position of device 201 may include information associated with a distance, direction, orientation, or other parameter. For example, the position of device 201 relative to device 202 may be determined using trigonometry. For example, if device 201 is displaced by a=10 cm and 160 degrees from a reference point, and device 202 is displaced by b=5 cm and 20 degrees from the reference point, then the distance between devices 201-202, c, may be determined using the law of cosines, c²=a²+b²−2ab cos (160−20), and c=12 cm. The direction of device 201 relative to device 202 may also be determined. As another example, device 201 may be rotated by 10 degrees, and device 202 may be rotated by −10 degrees, then the orientation of device 201 relative to device 202 may be 20 degrees. Still, other methods for determining a position may be used. For example, a GPS may be used to determine the longitudinal and latitudinal coordinates of devices 201-202.

Audio signal determinator 216 may be configured to configure, modify, adjust, generate, or determine an audio signal to be presented at device 201 and/or device 202 as a function of the position of device 201. For example, an audio effect may be presented by devices 201-202. Audio signal determinator 216 may determine the audio signals or audio channels to be presented at devices 201-202 such that the audio effect is presented. More than one loudspeaker may be coupled to each of devices 201-202. Audio signal determinator 216 may determine the audio signal to be presented at a plurality of loudspeakers. For example, a surround sound audio content may have a left channel and a right channel. Audio signal determinator 216 may determine whether device 201 should present the left channel or the right channel based on whether it is to the right or to the left of device 202. As another example, audio signal determinator 216 may modify or adjust the audio signals to be presented based on the positions of devices 201-202 using 2D or 3D audio techniques or algorithms.

As another example, audio signal determinator 216 may terminate a transmission of data between devices 201-202 based on the position of device 201 relative to device 202. For example, a distance between device 201 and device 202 may exceed a threshold, and position manager 210 may determine that audio signals should be provided on device 201 but not on device 202. Audio signal determinator 216 may transmit a control signal to stop the presentation of audio at device 202, may stop transmission of data representing an audio signal to device 202, and the like. In one example, based a position of device 201 relative to device 202, audio signal determinator 216 may determine that device 201 should present a left audio channel and device 202 should present a right audio channel, which may together provide an audio effect. Each device 201-202 may have a left speaker and a right speaker. Device 201 may present the left audio channel at both its left and right speakers, while device 202 may present the right audio channel at both its left and right speakers. In one example, device 201 may then be moved further away from device 202, and the distance between devices 201-202 may exceed a threshold. In another example, device 202 may be rotated, and the orientation angle between devices 201-202 may exceed a threshold. Audio signal determinator 216 may determine that device 202 should stop presenting the right audio channel, and may determine that the left speaker of device 201 should present the left audio channel and the right speaker of device 201 should present the right audio channel. Still other operations may be performed by audio signal determinator 216 and position manager 210 as a function of the position of device 201.

User interface 221 may be configured to exchange data between device 201 and a user. User interface 221 may include one or more input-and-output devices, such as a keyboard, mouse, audio input (e.g., speech-to-text device), display (e.g., LED, LCD, or other), monitor, cursor, touch-sensitive display or screen, and the like. User interface 221 may be used to enter a user command to initiate a process of determining a position of device 201. User interface 221 may be used to create or modify a bump template, a terminating motion template, or other templates to be used to determine command signals or gestures. User interface 221 may be used to create or modify operations that may be performed by audio signal determinator 216, or other operations performed by position manager 210. Still, user interface 221 may be used for other purposes.

Speaker 222 may include one or more transducers or loudspeakers. Speaker 222 may be configured to generate audio signal as directed by audio signal determinator 216. Speaker 222 may also generate acoustic signals to transmit data to another device. The acoustic signal may include a vibration, sound, ultrasound, infrasound, and the like. For example, Morse code may be used to encode acoustic signals and transmit data. Other examples for encoding data on an acoustic signal are described at co-pending U.S. patent application Ser. No. 14/266,697, filed Apr. 30, 2014, entitled “Pairing Devices Using Acoustic Signals.”

Microphone 223 may include one or more transducers or microphones. Microphone 223 may be used to receive voice commands from a user. Microphone 223 may be used to determine an ambient audio signal. Microphone 223 may be used to receive acoustic signals encoded with data, as described above.

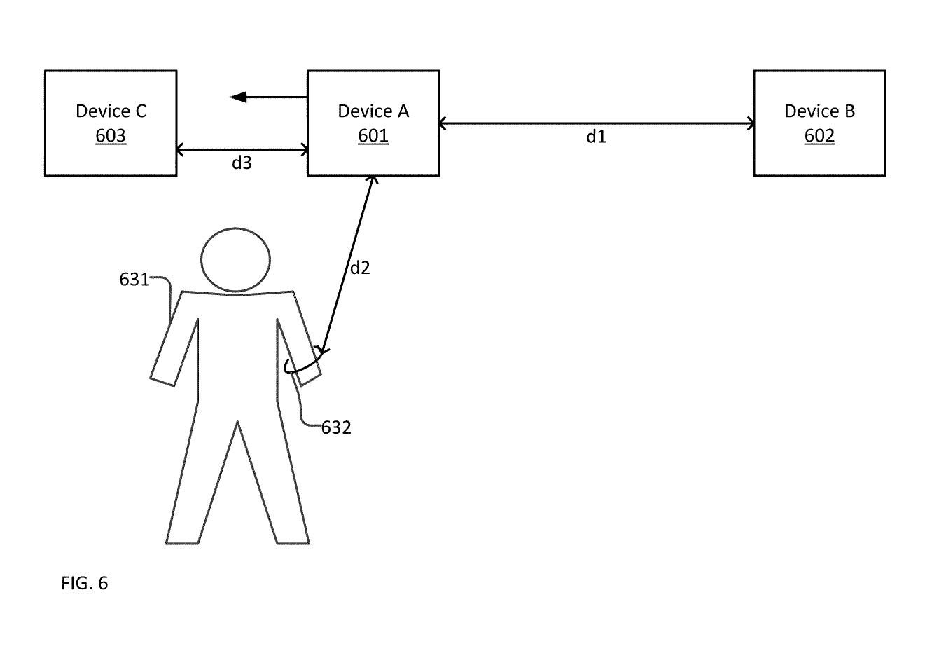

Sensor 225 may include one or more sensors and may include a variety of sensors, such as a location sensor (e.g., a GPS receiver or other location sensor), a thermometer, an altimeter, a light sensor, a proximity sensor (e.g., a sensor that may detect a strength of a data signal), an ultrasonic sensor, and the like. Sensor 225 may be used in lieu of or in conjunction of motion sensor 224 to gather data, which may be used to determine a displacement or rotation of device 201, to determine a bump, terminating motion, or other gesture or command associated with device 201, and the like. Sensor 225 may be used to determine a distance between device 201 and a user, or a distance between device 201 and a wearable device of a user, which may be used to determine an operation or functionality of device 201 (see, e.g., FIG. 6).

FIG. 3 illustrates motion data to be used for positioning devices, according to some examples. As shown, FIG. 3 includes an x-z plane 350, device A 301 (at a first time 301a, at a second time 301b, and at a third time 301c), device B 302, surfaces 351-352, a first portion of x-axis motion data 331, a second portion of x-axis motion data 332, a third portion of x-axis motion data 333, a first portion of z-axis motion data 341, a second of z-axis motion data 342, and a third portion of z-axis motion data 343. FIG. 3 also includes a flow sequence associated with pairing, including a process of pairing 361, remaining paired 362, and disconnecting 363. In some examples, the x-axis may be a horizontal axis, and the z-axis may be a vertical axis. Portions of motion data 331-333 and 341-343 may be captured by one or more motion sensors coupled to device A 301. In some examples, portions of motion data 331-333 and 341-343 may represent x-axis and z-axis accelerations captured by one or more accelerometers. In one example, device A 301a and device B 302 are bumped together, indicating a starting point for a process of positioning devices A and B 301-302. Device A 301a and device B 302 may initially be sitting on surface 351, which may be a surface of a table, floor, shelf, and the like. Device A 301a and device B 302 may then be picked up, and moved in the +z direction. Device A 301a may be moved in the +x direction to bump against device B 302. At the time of the bump, device A 301a may experience a sudden decrease in acceleration. Device A 301b may then move to the left, in the −x direction. Device A 301c may then be placed down on surface 352, which may be the surface of a table, floor, shelf, and the like, and moved in the −z direction. This movement may be captured by portions of motion data 331-333 and 341-343, detected by one or more motion sensors coupled to device A 301. As shown, for example, the first portion of x-axis motion data 331 may indicate a gradual increase, then a sudden drop. The gradual increase may correspond with device A 301a being moved in the +x direction to bump against device B 302. The sudden drop may correspond to the moment of the bump, when device A 301a's motion in the x-axis decelerates. As shown, for example, before device A 301a is moved, the first portion of z-axis motion data 341 may initially reflect an acceleration caused by a gravitational force in the −z direction. As device A 301a is picked up from surface 351 and moved upward, motion data 341 may indicate a gradual decrease, and as device A 301a stops moving upward, motion data 341 may indicate a gradual increase. In some examples, device A 301 may be moved in the y-axis, and a portion of y-axis motion data may be captured. Portions of motion data 331 and 341 may be compared with one or more templates or conditions associated with a bump. In some examples, only data in one axis may be used. In some examples, data in all axes may be used. In some examples, a bump condition may require a decrease in x-axis acceleration above a threshold. In some examples, a bump condition may require a match with a motion template having a gradual change (e.g., a first rate of change) in x-axis acceleration, and then a sudden change (e.g., a second rate of change, which is greater than the first rate of change) in x-axis acceleration in the opposite direction. In some examples, a bump may be found if the x-axis motion data 331 and z-axis motion data 341 match respective conditions. A match may be found, or a condition may be considered satisfied, if portions of motion data 331 or 341 fall within a tolerance or range. Additionally, other types of data (not shown) may be used to determine or confirm a bump. For example, a proximity sensor may be used to detect whether device B 302 is within a proximity of device A 301a. The proximity sensor may have a variety of implementations, such as detecting a power level of a data signal received from device B 302, detecting ultrasonic signals to determine a distance with another object, communicating data via NFC, and the like. Portions of motion data 331 and 341 may be used together with proximity data, or other types of data, to match one or more conditions associated with a bump. After a bump is found, the following portions of motion data 332 and 342 may be used to determine a displacement, rotation, or other parameter associated with a position of device A 301. Still, as previously described, gestures or command signals other than a bump may be used.

As described above, device A 301b may be moved in the −x direction (e.g., relative to device 302). In one example, device A 301b may first experience an acceleration to reach a certain speed in the −x direction. Once that speed is reached, acceleration may become zero. Device A 301b may have no change in the vertical height during this time. As shown, for example, the beginning of the portion of x-axis motion data 332 may indicate a negative acceleration, corresponding to an increase in acceleration in the −x direction. Portion of x-axis motion data 332 may become zero as device A 301b attains a constant speed in the −x direction. Portion of z-axis motion data 342 may be constant, which may indicate that device A 301b is not being moved in the z direction. Motion data 342 may reflect a gravitational force experienced by device A 301b. Still, device A 301b may be moved in different paths, including in the y-axis, which may result in different portions of motion data in the different axes. In some examples, device A 301b may be rotated, which may also result in different motion data from different motion sensors in different axes. Portions of motion data 332 and 342 (and in some examples other portions of motion data) may be used to determine a displacement, rotation, or other parameter associated with a position of device A 301b, as is described below with respect to FIGS. 4A and 4B.

In some examples, device A 301c may be placed on surface 352, which may indicate an end point for the movement of device A 301. As shown, for example, as the movement of device A 301c is slowed down in the −x direction, portion of x-axis motion data 333 may indicate a gradual increase. As device A 301c comes to a complete stop on surface 352, portion of motion data 333 may decrease to zero. For example, as device A 301c is moved downward to be placed on surface 352, portion of z-axis motion data 343 may indicate an increase. As device A 301c hits surface 352, portion of motion data 343 may indicate a decrease. As device A 301c comes to a rest, portion of motion data 343 may reflect only the gravitational force experienced by device A 301c. Portions of motion data 333 and 343 may be compared with one or more templates or conditions associated with a terminating motion. As described above, other data types may also be included in the templates or conditions. For example, an ultrasonic signal may be used to detect the proximity of surface 352 to device A 301c. Once a terminating motion is found, a position manager may determine a displacement and/or rotation of device A 301 using the preceding portion of motion data. The portion of motion data (e.g., portions 332 and 342) between a portion of motion data that matches a bump template (e.g., portions 331 and 341) and another portion of motion data that matches a terminating motion template (e.g., portions 333 and 343) may be used to determine a displacement, rotation, or other parameter associated with a position of device A 301. As described above, other gestures or command signals may be used to indicate an end point of the movement of device A 301.

In some examples, a pairing of device A 301 with device B 302 may occur in parallel with a determining of a position of device A 301. For example, an initiating motion (e.g., a bump) may initiate or prompt a process of pairing 361. While the initiating motion may indicate a beginning of the portion of motion data to be used for determining a displacement, the initiating motion may also being a process of pairing 361. The process of pairing 361 may include device A 301 identifying device B 302 (e.g., using an address, name, other identifier, etc.), device A 301 performing handshake procedures with device B 302 (e.g., exchanging keys, nonces, random numbers, etc.), device A 301 generating a shared key or link key that may be used to authenticate a pairing or trusted relationship with device B 302, encrypting data that is exchanged between device A 301 and device B 302, and the like. Pairing of devices is also described in co-pending U.S. patent application Ser. No. 14/266,697, filed Apr. 30, 2014, entitled “Pairing Devices Using Acoustic Signals,” which is incorporated by reference herein in its entirety for all purposes. After being paired, device A 301 and device B 302 may remain paired, as indicated by 362. While device A 301 and device B 302 remain paired, device A 301 and device B 302 may exchange data (e.g., data representing an audio signal or audio channel, data representing user settings, etc.), control signals, and the like. At a later point in time, device A 301 and device B 302 may become disconnected, as indicated by 363. The disconnection may be triggered when device A 301 is moved away from device B 302, and the distance of device A 301 from device B 302 exceeds a threshold. The disconnection may also be triggered by another command signal or prompt (e.g., a button press, data signals becoming out of range, etc.).

FIGS. 4A and 4B illustrate a displacement and orientation of a device, according to some examples. As shown, FIG. 4A includes an x-y-z axis 430, device A 401 (at an initial position 401a and at an end position 401b), a path or distance traveled by device A 432, samples of motion data along the path 432a-d, a magnitude of a displacement of device A 431, and a direction of a displacement of device A 0. In some examples, device A 401 may be moved from initial position 401a to end position 401b along path 432 in the x-y plane. Motion data may be captured by one or more motion sensors coupled to device A. Motion data may be periodically sampled, for example, at points 432a-d along path 432. Each sample point 432a-d may include 1-, 2-, or 3-axis of data. Based on the samples of motion data, positions of device A may be determined. For example, position data may be determined through integrating acceleration data, and a final position 401b may be determined. The final position 401b may be used to determine a displacement 431 and direction, with angle θ. The angle of the direction θ may be given with respect to the x-axis, as shown. In some examples, device A 401 may be moved in the z-plane. Another angle of direction may be determined, with reference to the z-axis.

As shown, FIG. 4B includes an x-y-z axis 430, device A 401 (at an initial orientation 401c and at an end orientation 401d), a front side 403a of device A at the initial orientation, a front side 403b of device A at the end orientation, loudspeakers 404a-406a at the initial position, loudspeakers 404b-406b at the end position, and an angle of rotation a. In some examples, one or more loudspeakers may be coupled to different places at device A 401. In one example, device A 401 may be rotated in the x-y plane, such that its final position makes an angle α with its initial position. Motion data may be captured by one or more sensors coupled to device A. For example, rotation may be measured by one or more gyroscopes or accelerometers. In some examples, device A 401 may be rotated in the z plane, or another plane. Another angle of rotation, such as in the z-plane, may be captured by one or more motion sensors. The angle α may be used to determine positions of loudspeakers 404-406. As described above, the rotation of device A 401 may be used to determine an orientation of device A 401 relative to another device, which may be used to determine the positions and directions of loudspeakers 404-406 of device A 401 to loudspeakers of another device. Position manager may determine audio signals to be presented at each of loudspeakers 404-406 based on the orientation or rotation of device A 401.

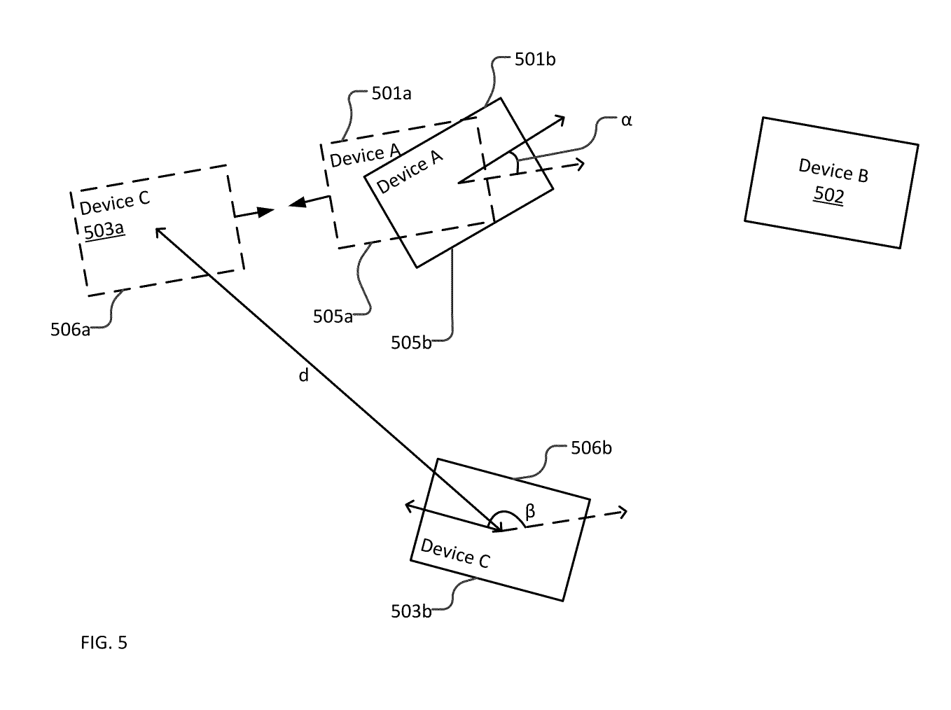

FIG. 5 illustrates a positioning of more than two devices using motion data, according to some examples. As shown, FIG. 5 includes device A 501 (at an initial position 501a and at an end position 501b), device B 502, device C 503 (at an initial position 503a and at an end position 503b), a front side 505 of device A (at an initial position 505a and at an end position 505b), a front side 506 of device C (at an initial position 506b and a tan end position 506b), an angle of rotation of device A α, an angle of rotation of device C β, and a distance between the final positions of device A and device C d. In some examples, device A 501 and device B 502 may be initially paired in a network, and their relative positions may be known by a position manager (e.g., using the processes and techniques described above). Device C 503 may be added to the network. Device A 501 and device C 503 may be bumped together. A portion of motion data captured by a motion sensor coupled to device A 501 may match a bump template, indicating an initial position for determining a displacement and a direction. Device A 501 may be moved from its initial position 501a to its end position 501b. Another portion of motion data may be used to determine a displacement from 501a to 501b, including a magnitude and direction of the displacement. This portion of motion data may also be used to determine a rotation angle α from position 501a to position 501b. Finally, device A 501 may be placed down. A final portion of motion data captured by a motion sensor coupled to device A 501 may match a terminating motion template, indicating an end position. Based on the displacement and rotation from the initial position 501a to the end position 501b, and the original position of device A 501a relative to device B 502, the new position of position A 501b relative to device B 502 may be determined.

After the bump, device C may be moved from its initial position 503a to its end position 503b. As described above, a position of device C 503 relative to device A 501 may be determined using motion data and/or other data. A first portion of motion data may match a bump template, and a third portion of motion data may match a terminating motion template. A second portion of motion data, between the first portion and the third portion, may be used to determine a displacement of device C from position 503a to position 503b, including magnitude d and an angle of direction (not shown). The second portion of motion data may also be used to determine a rotation angle R. Based on the displacement and rotation of device A from position 501a to position 501b, and the displacement and rotation of device C from position 503a to position 503b, the relative positions of device A 501 and device C 503 may be determined. Finally, using the relative positions of device A 501 and device 502 B, the position of device C 503b relative to device B 502 may be determined. Still, other processes or methods may be used for positioning more than two devices using motion data.

FIG. 6 illustrates an operation of a device based on a positioning of the device using motion data as well as a distance between the device and a user, according to some examples. As shown, FIG. 6 includes device A 601, device B 602, device C 603, a distance d1 between devices A and B, a distance d3 between devices A and C, a user 631, and a wearable device 632. Wearable devices 632 may be worn around an arm, leg, ear, or other bodily appendage or feature, or portable in a user's hand, pocket, bag or other carrying case. As an example, wearable device 632 may be a data-capable strapband. Other wearable devices include a smartphone or mobile device, headset, tablet, laptop other computing device, and the like. One or more sensors, including a motion sensor, may be coupled to wearable device 632. The sensors may be local to or remote from wearable device 632. Wearable device 632 may also be capable of data communications over a network (e.g., Wi-Fi, Bluetooth, ZigBee, 3G, 4G, and the like). In some examples, the relative positions of device A 601, device B 602, and device C 603 may be determined by a position manager (using the processes and techniques described above). Device A 601 and device B 602 may be paired or otherwise jointly present an audio effect or audio content. For example, a position manager may cause device A 601 to present a first audio channel and device B 602 to present a second audio channel, which may together provide surround sound, 3D audio, or another audio experience. In some cases, device A 601 may transmit a control signal to device B 602 to present the second audio channel at device B 602. In some cases, device A 601 may transmit data representing the second audio channel to device B 602. Still, other data may be transmitted between device A 601 and device B 602. Subsequently, user 631 may move device A 601 away from device B 602. Distance d1 may be determined based on motion data received from a motion sensor coupled to device A 601. If distance d1 exceeds a threshold, the position manager may disconnect device A 601 and device B 602, or terminate an interaction between device A 601 and device B 602. In some examples, the position manager may terminate a transmission of data from device A 601 to device B 602. In some examples, the position manager may cause no audio signal to be presented at device A 601 and/or device B 602. Still, other operations may be performed.

In some examples, a distance d2 between device A 601 and wearable device 632 may be determined. In some examples, distance d2 may be determined using a proximity sensor coupled to device A 601. Distance d2 may be determined based on a received signal strength indicator (RSSI), or a signal strength of a radio signal transmitted from wearable device 632. In some examples, distance d2 may be determined using an ultrasonic sensor coupled to device A 601. Still, other methods of determining distance d2 may be used. A position manager may determine that distance d1 has exceeded a first threshold, and that device A 601 and device B 602 should be disconnected. Position manager may determine that presentation of an audio signal should be terminated at one of device A 601 and device B 602. Position manager may further determine that distance d2 is less than a second threshold. In some examples, position manager may determine that distance d2 is less than the distance between device B 602 and wearable device 632. Based on distance d2, position manager may terminate presentation of an audio signal at device B 602, and may continue presentation of an audio signal at device A 601. In some examples, the audio signal presented at device A 601 may be changed or modified after termination of the presentation of an audio signal at device B 602. For example, before the disconnection, device A 601 may present a first audio channel configured to produce an audio effect together with a second audio channel being presented at device B 602. After the disconnection, device A 601 may present a different audio signal, which may be configured to provide the audio effect, or a different audio experience, without the interaction with device B 602. For example, while device A 601 and device B 602 may each present a left channel and a right channel prior to movement, after device A 601 is moved above a threshold distance away from device B 602, device B 602 may stop presenting an audio signal, while device A 601 may present both the left channel and the right channel to present an audio effect.

In some examples, a distance d3 between device A 601 and device C 603 may be determined. As described above, in some examples, the relative positions of device A 601, device B 602, and device C 603 may be determined by a position manager (using the processes and techniques described above). As user 631 moves device A 601 away from device B 602, he may move device A 601 closer to device C 603. Distance d3 may be determined based on motion data received from a motion sensor coupled to device A 601. If distance d3 falls below a threshold, a position manager may connect device A 601 and device C 603, or initiate an interaction between device A 601 and device C 603. In some cases, the position manager may cause presentation of audio signals at device A 601 and device C 603, which may together present an audio effect such as surround sound, 3D audio, or other. The audio signals may be selected or determined as a function of the position of device A 601 relative to device C 603. The position manager may cause transmission of other control or data signals between device A 601 and device C 603. Still, other interactions may be performed based on the movement of device A 601, device B 602, or device C 603, as detected by motion data and/or other types of data. The position manager may be implemented on device A 601, device B 602, device C 603, or a remote device or server. The position manager may also be distributed across device A 601, device B 602, device C 603, and/or a remote device or server.

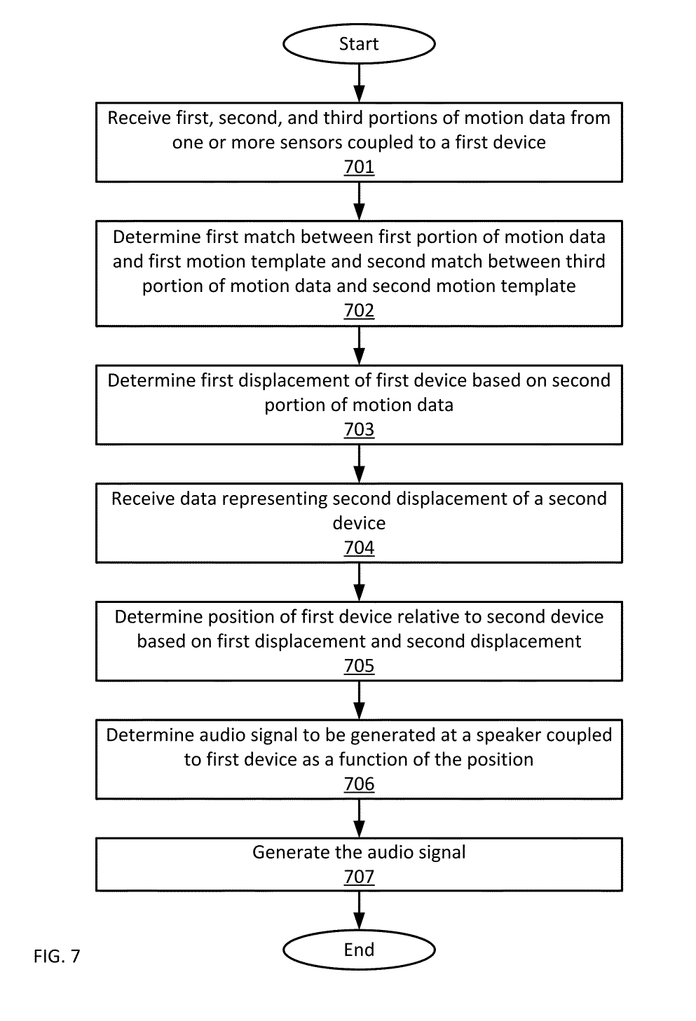

FIG. 7 illustrates a process for a position manager, according to some examples. At 701, a first portion of motion data, a second portion of motion data, and a third portion of motion data may be received from one or more sensors coupled to a first device. Other data, such as proximity data, location data, and the like, may also be received from one or more sensors coupled to the first device or another device. At 702, a first match between the first portion of motion data and a first motion template, and a second match between the third portion of motion data and a second motion template may be determined. The first motion template may be associated with a motion or gesture that may be used to indicate an initial position for determining a displacement of the first device, such as a bump with a second device. The second motion template may be associated with a motion or gesture that may be used to indicate an end position, such as placing down of the first device, or another terminating motion. Still, other command signals may be used (e.g., a button press, a user interface, a voice command, etc.). The first and second motion templates may include one or more patterns or conditions, which may be compared with the portions of motion data. A match may be determined if there is a substantial similarity, or a match with a tolerance. At 703, a first displacement of the first device may be determined based on the second portion of motion data. The second portion of motion data may be between the first and third portions of motion data. In some examples, the second portion of motion data may include acceleration data, which may be integrated to determine a displacement. At 704, data representing a second displacement of the second device may be received. The second displacement may be received using a radio signal (e.g., Bluetooth, etc.), an acoustic signal, or other signal. In some cases, the second displacement may be determined locally by the position manager, based on motion data received from the second device. At 705, a position of the first device relative to the second device may be determined based on the first displacement and the second displacement. This may be done using trigonometry, mathematical formulas, or other techniques. The position may include information associated with a distance between the first and second devices, a direction of the first device from the second device, an orientation of the first device relative to the second device, and the like. At 706, an audio signal to be generated at a speaker coupled to the first device is determined as a function of the position of the first device. The audio signal may be an audio channel that is configured to present an audio effect in conjunction with one or more audio channels presented from sources at different locations. At 708, the audio signal may be generated. Still, other implementations of a position manager may be used.

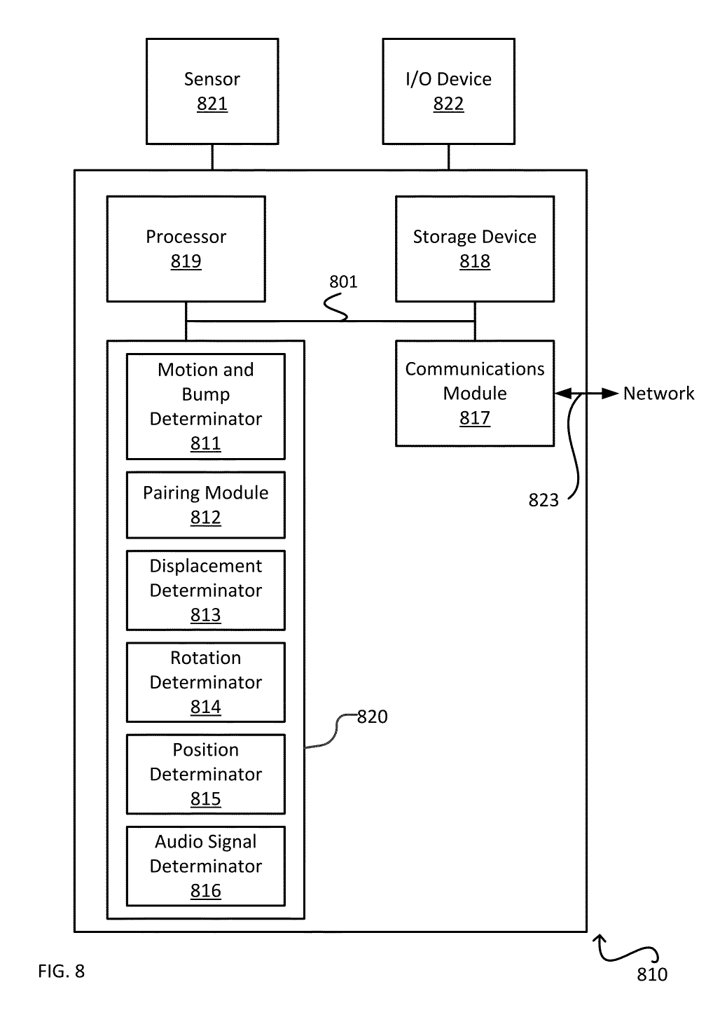

FIG. 8 illustrates a computer system suitable for use with a position manager, according to some examples. In some examples, computing platform 810 may be used to implement computer programs, applications, methods, processes, algorithms, or other software to perform the above-described techniques. Computing platform 810 includes a bus 801 or other communication mechanism for communicating information, which interconnects subsystems and devices, such as processor 819, system memory 820 (e.g., RAM, etc.), storage device 818 (e.g., ROM, etc.), a communications module 817 (e.g., an Ethernet or wireless controller, a Bluetooth controller, etc.) to facilitate communications via a port on communication link 823 to communicate, for example, with a computing device, including mobile computing and/or communication devices with processors. Processor 819 can be implemented with one or more central processing units (“CPUs”), such as those manufactured by Intel® Corporation, or one or more virtual processors, as well as any combination of CPUs and virtual processors. Computing platform 810 exchanges data representing inputs and outputs via input-and-output devices 822, including, but not limited to, keyboards, mice, audio inputs (e.g., speech-to-text devices), speakers, microphones, user interfaces, displays, monitors, cursors, touch-sensitive displays, LCD or LED displays, and other I/O-related devices. An interface is not limited to a touch-sensitive screen and can be any graphic user interface, any auditory interface, any haptic interface, any combination thereof, and the like. Computing platform 810 may also receive sensor data from sensor 821, including a heart rate sensor, a respiration sensor, an accelerometer, a motion sensor, a galvanic skin response (GSR) sensor, a bioimpedance sensor, a GPS receiver, and the like.

According to some examples, computing platform 810 performs specific operations by processor 819 executing one or more sequences of one or more instructions stored in system memory 820, and computing platform 810 can be implemented in a client-server arrangement, peer-to-peer arrangement, or as any mobile computing device, including smart phones and the like. Such instructions or data may be read into system memory 820 from another computer readable medium, such as storage device 818. In some examples, hard-wired circuitry may be used in place of or in combination with software instructions for implementation. Instructions may be embedded in software or firmware. The term “computer readable medium” refers to any tangible medium that participates in providing instructions to processor 819 for execution. Such a medium may take many forms, including but not limited to, non-volatile media and volatile media. Non-volatile media includes, for example, optical or magnetic disks and the like. Volatile media includes dynamic memory, such as system memory 820.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 801 for transmitting a computer data signal.

In some examples, execution of the sequences of instructions may be performed by computing platform 810. According to some examples, computing platform 810 can be coupled by communication link 823 (e.g., a wired network, such as LAN, PSTN, or any wireless network) to any other processor to perform the sequence of instructions in coordination with (or asynchronous to) one another. Computing platform 810 may transmit and receive messages, data, and instructions, including program code (e.g., application code) through communication link 823 and communication interface 817. Received program code may be executed by processor 819 as it is received, and/or stored in memory 820 or other non-volatile storage for later execution.

In the example shown, system memory 820 can include various modules that include executable instructions to implement functionalities described herein. In the example shown, system memory 820 includes a motion and bump determination module 811, a pairing module 812, a displacement determination module 813, a rotation determination module 814, a position determination module 815, an audio signal determination module 815, and an audio signal determination module 816.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
receiving a portion of motion data from one or more sensors coupled to a first device;
generating data representing a first displacement of a first device relative to a reference point based on the portion of motion data;
determining a position of the first device relative to a position of a second device based on the first displacement;
determining an audio signal to be generated at a speaker coupled to the first device as a function of the position of the first device; and
causing generation of the audio signal at the speaker coupled to the first device.

2. The method of claim 1, further comprising:
determining an initiating motion associated with a beginning of the portion of motion data; and
determining a terminating motion associated with an end of the portion of motion data.

3. The method of claim 2, further comprising:
causing a pairing of the first device with the second device based on the initiating motion.

4. The method of claim 1, further comprising:
receiving an initiating portion of motion data and a terminating portion of motion data, the portion of motion data being between the initiating portion of motion data and the terminating portion of motion data; and
determining a first match between the initiating portion of motion data and an initiating motion template, and a second match between the terminating portion of motion data and a terminating motion template.

5. The method of claim 1, further comprising:
receiving data representing a second displacement of the second device; and
determining the position of the first device relative to the position of the second device based on the first displacement and the second displacement.

6. The method of claim 5, further comprising:
receiving an electromagnetic signal from the second device within a time range of the receiving the portion of motion data; and
determining a power level associated with the electromagnetic signal is above a threshold power level.

7. The method of claim 5, further comprising:
determining another audio signal to be generated at another speaker coupled to the second device as a function of the position of the first device,
wherein the audio signal and the another audio signal are configured to provide an audio effect.

8. The method of claim 5, further comprising:
receiving data representing a third displacement of a third device; and
determining another position of the first device relative to a position of the third device based on the third displacement.

9. The method of claim 5, wherein the data representing the second displacement of the second device is received using one of a Bluetooth communications protocol and an acoustic signal.

10. The method of claim 1, further comprising:
determining a distance between the first device and the second device exceeds a threshold distance based on the position of the first device; and
terminating a transmission of data from the first device to the second device.

11. The method of claim 1, further comprising:
determining a distance between the first device and the second device exceeds a threshold distance based on the position of the first device;
determining another distance between the first device and a wearable device is below another threshold distance; and
causing no audio signal to be presented at another speaker coupled to the second device.

12. The method of claim 1, further comprising:
determining a rotation of the first device based on the portion of motion data,
wherein data representing the position of the first device comprises data representing an orientation of the first device relative to the second device.

13. The method of claim 1, wherein data representing the position of the first device comprises data representing a distance between the first device and the second device.

14. The method of claim 1, wherein data representing the position of the first device comprises data representing a direction of the first device relative to the second device.

15. The method of claim 1, further comprising:
receiving another portion of motion data from the one or more sensors coupled to the first device;
determining a second displacement of the first device based on the another portion of motion data; and
determining another position of the first device relative to the position of the second device based on the first displacement and the second displacement.

16. A system, comprising:
a memory configured to store a portion of motion data received from one or more sensors coupled to a first device; and
a processor configured to generate data representing a first displacement of a first device relative to a reference point based on the portion of motion data, to determine a position of the first device relative to a position of a second device based on the first displacement, to determine an audio signal to be generated at a speaker coupled to the first device as a function of the position of the first device, and to cause generation of the audio signal at the speaker coupled to the first device.

17. The system of claim 14, wherein:
the processor is further configured to determine an initiating motion associated with a beginning of the portion of motion data, and to determine a terminating motion associated with an end of the portion of motion data.

18. The system of claim 14, where:
the processor is further configured to receive data representing a second displacement of the second device, and to determine the position of the first device relative to the position of the second device based on the first displacement and the second displacement.

19. The system of claim 18, wherein:
the processor is further configured to determine another audio signal to be generated at another speaker coupled to the second device as a function of the position of the first device, and
the audio signal and the another audio signal are configured to provide an audio effect.

20. The system of claim 14, wherein the processor is further configured to determine a distance between the first device and the second device exceeds a threshold distance based on the position of the first device, and to terminate a transmission of data from the first device to the second device.
